(19) United States
(12) Patent Application Publication
(10) Pub. No.: US 2018/0354142 A1
(43) Pub. Date: Dec. 13, 2018

(54) AUTOMATED PICKING APPARATUS WITH MAGNETIC REPULSION FOR PICKING AN OBJECT OR A SET OF OBJECTS AND METHOD THEREOF

(71) Applicant: AEM SINGAPORE PTE. LTD., Singapore (SG)

(72) Inventor: See Jean Chan, Singapore (SG)

(21) Appl. No.: 15/780,845

(22) PCT Filed: Jun. 30, 2016
(86) PCT No.: PCT/SG2016/050309

§ 371 Date: Jun. 1, 2018

(30) Foreign Application Priority Data
Jun. 30, 2016 (SG) 2016/050309

(51) Int. Cl. B25J 15/06; B25J 13/08; B25J 9/00

(52) U.S. Cl. CPC B25J 15/0616; B65G 47/92; B25J 9/0084; B25J 13/086

(57) ABSTRACT

An automated picking apparatus for picking an object disposed on a surface. The automated picking apparatus comprises: a picking device displaceable toward the surface for picking the object; a compensator device co-operably connected to the picking device, the compensator device comprising a first magnet and a second magnet separated by a distance and arranged to repel away from each other; and an actuating mechanism operable for displacing the picking device toward the surface for picking the object, wherein operation of the actuating mechanism activates the compensator device and displaces the picking device co-operably connected thereto; wherein activation of the compensator device reduces the distance between the first and second magnetic elements thereof; and wherein continued operation of the actuating mechanism subsequent to contact between the picking device and the object further reduces the distance between the first and second magnetic elements of the compensator device.

### TECHNICAL FIELD

The present disclosure relates generally to an automated picking apparatus and a method for picking one or a set of work pieces, components or objects disposed on a surface, such as that found in the pick and place system used in the assembly line for producing electronic finished goods.

### BACKGROUND

In pick and place assembly process, a picking device is often required to make good contact with a work piece or component resting on a surface to successfully pick up the work piece or component from the surface. Too little contact with the work piece or component can result in either unsuccessful pick up or premature dropping of the work piece or component. Too much contact with the work piece or component can result in the picker damaging the work piece or component due to excessive pressure exerted on the work piece or component. Ideally, all the work pieces or components to be picked up are all at the same level or at the same distance away from the picking device. However, in reality, the surface on which the work pieces or components are sitting can be uneven or non-planar. The work pieces or components themselves can be of different height due to manufacturing process variation. There can be error in calculating the distance between picking device and the work piece or component due to calibration problem or reference point problem. In high volume manufacturing where multiple picking devices are used to pick multiple work pieces or components concurrently, some picking devices will make contact with work pieces or components earlier than others due to the variations and problems described above. In order to have good contact with all the work pieces or components, the drive mechanism will continue to extend the picking devices until all the picking devices are in good contact with all the work pieces or components. The additional advancement of the picking devices which has made earlier contact with the work pieces or components often results in damaging either the work piece or the component or the picking device due to the excessive pressure between them. Multiple picking devices can also be used to pick up a large work piece or object. The surface of the large workpiece or object can be uneven or non-planar. Some picking devices will make contact with the large work piece or object earlier than others. In order for all the picking devices to have good contact with the large work piece or object, the drive mechanism will continue to extend the picking devices until all the picking devices are in good contact with the large work piece or object. The additional advancement of the picking devices which has made earlier contact with the large work piece or object often results in damaging either the work piece or the object or the picking device due to the excessive pressure between them.

A conventional way to cater for the differences in distance between picking devices and the work pieces or components is to spring load the picking devices. The spring on the picking devices provides the capacity for compression such that after a picking device makes contact with a work piece or a component, further attempt to extend the picking devices will, instead of advancing the picking device that is already in contact with the work piece or component further, compress the spring due to the reaction force exerted on the picking device as the picking device is stopped by the work piece or component, thus reducing the pressure on the work piece or component. So, where multiple picking devices are picking work pieces or components concurrently, the picking devices which make contact with work pieces or components earlier will have their springs compressed while the rest of the picking devices continue to extend until they are in contact with the work pieces or components. While the use of springs can compensate for the differences in distance between picking devices and work pieces or components, it has some problems. Springs may suffer from mechanical wear and tear after multiple uses and loses compressibility due to material fatigue. Springs can also be jammed within the coils during compression and not be able to become uncompressed. Frequent change of springs in high volume manufacturing reduces productivity and is not cost efficient.

### SUMMARY

According to a first aspect of the present disclosure, there is an automated picking apparatus for picking an object. The automated picking apparatus comprises: a picking device; and a compensator device operable in cooperation with the picking device, the compensator device comprising a first magnetic element and a second magnetic element separated by a distance and arranged to repel away from each other; wherein the distance between the first and second magnetic elements of the compensator device is adjustable with the displacement of the picking device relative to the object; and wherein displacement of the picking device subsequent to contact between the picking device and the object reduces the distance between the first and second magnetic elements of the compensator device.

According to a second aspect of the present disclosure, there is an automated picking apparatus for picking a set of objects, the set of objects including a first object and a second object. The automated picking apparatus comprises: a set of picking devices including a first picking device and a second picking device for picking the first and second objects, respectively; and a set of compensator devices operable in cooperation with the set of picking devices, the set of compensator devices including a first compensator device and a second compensator device, each of the first and second compensator devices comprising a first magnetic element and a second magnetic element separated by a distance and arranged to repel away from each other, wherein the distances between the first and second magnetic elements of the first and second compensator devices are adjustable with displacement of the first and second picking devices relative to the first and second object, respectively; wherein the first picking device contacts the first object before the second picking device contacts the second object; and wherein subsequent to contact between the first picking device and the first object, displacement of the second picking device toward the second object reduces the distance between the first and second magnetic elements of the first compensator device.

According to a third aspect of the present disclosure, there is a method for picking an object disposed on a surface. The method comprises: displacing a picking device toward the object; activating a compensator device, wherein the compensator device is operable in cooperation with the picking device, the compensator device comprising a first magnetic element and a second magnetic element separated by a distance and arranged to repel away from each other; and reducing the distance between the first and second magnetic elements of the compensator device in response to activation of the compensator device and while the picking device is being displaced toward the object, wherein subsequent to contact between the picking device and the object, continued activation of the compensator device further reduces the distance between the first and second magnetic elements of the compensator device.

According to a fourth aspect of the present disclosure, there is a method for picking a set of objects, the set of objects including a first object and a second object. The method comprises: displacing a set of picking devices including a first picking device and a second picking device, for picking the first and second objects, respectively; activating a set of compensator devices, the set of compensator devices coupled to the set of picking devices and including a first compensator device and a second compensator device, wherein each of the first and second compensator devices comprises a first magnet and a second magnet separated by a distance and arranged to repel away from each other, and wherein the first and second compensator devices are operable in cooperation with the first and second picking devices, respectively; reducing the distances between the first and second magnetic elements of the first and second compensator devices in response to activation thereof and while the first and second picking devices are being displaced toward the first and second object, displacing the first picking device until the first picking device contacts the first object before the second picking device contacts the second object; displacing the second picking device toward the second object subsequent to contact between the first picking device and the first object; and further reducing the distance between the first and second magnetic elements of the first compensator device, wherein the distance between the first and second magnetic elements of the first compensator device is reduced until the second picking device contacts the second object.

According to a fifth aspect of the present disclosure, there is a method for picking an object. The method comprises: displacing a set of picking devices, the set of picking devices including a first picking device and a second picking device, toward the object; activating a set of compensator devices, the set of compensator devices coupled to the set of picking devices and including a first compensator device and a second compensator device, wherein each of the first and second compensator devices comprises a first magnet and a second magnet separated by a distance and arranged to repel away from each other, and wherein the first and second compensator devices are operable in cooperation with the first and second picking devices, respectively; reducing the distances between the first and second magnetic elements of the first and second compensator devices in response to activation thereof and while the first and second picking devices are being displaced toward the object, displacing the first picking device until the first picking device contacts the object before the second picking device contacts the object; displacing the second picking device toward the object subsequent to contact between the first picking device and the object; and further reducing the distance between the first and second magnetic elements of the first compensator device, wherein the distance between the first and second magnetic elements of the first compensator device is reduced until the second picking device contacts the object.

An advantage of the present disclosure is that the compensator device allows for compensation of height differences of the objects placed on a non-planar or defective surface or an object of uneven or non-planar surface. The use of magnetic elements for the compensation device is advantageous because there will be minimal physical contact with other components, thereby minimizing damage and wear and tear. Due to less moving components, the risk of jamming or failures is significantly mitigated, thereby improving the reliability of the compensation device and consequently of the automated picking apparatus. The use of magnetic elements also enables the space between the two magnetic elements to be compressed until the elements touch each other whereas in the case of spring, the maximum compression is limited by the physical height of the string in the fully compressed state.

An automated picking apparatus and a method for picking an object or a set of objects disposed on a surface according to the present disclosure is thus disclosed hereinabove. Various features, aspects, and advantages of the present disclosure will become more apparent from the following detailed description of the embodiments of the present disclosure, by way of non-limiting examples only, along with the accompanying drawings in which like numerals represent like components.

### BRIEF DESCRIPTION OF THE DRAWINGS

FIG. 1 shows a front view of the automated picking apparatus with separated magnetic elements, in accordance with an embodiment of the present disclosure.

FIG. 2 shows a front view of the automated picking apparatus with the magnetic elements being together, in accordance with an embodiment of the present disclosure.

FIG. 3 shows a side view of a compensator device of the automated picking apparatus, in accordance with an embodiment of the present disclosure.

FIG. 4A shows a front view of the compensator device with the magnetic elements separated, in accordance with an embodiment of the present disclosure.

FIG. 4B shows a front view of the compensator device of FIG. 4A with the magnetic elements being closer together, in accordance with an embodiment of the present disclosure.

FIG. 5 shows a front view of an automated picking apparatus with two picking devices for picking two objects, in accordance with an embodiment of the present disclosure.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions. In general, an element of a set can include or be a system, an apparatus, a device, a structure, an object, a process, a physical parameter, or a value depending upon the type of set under consideration.

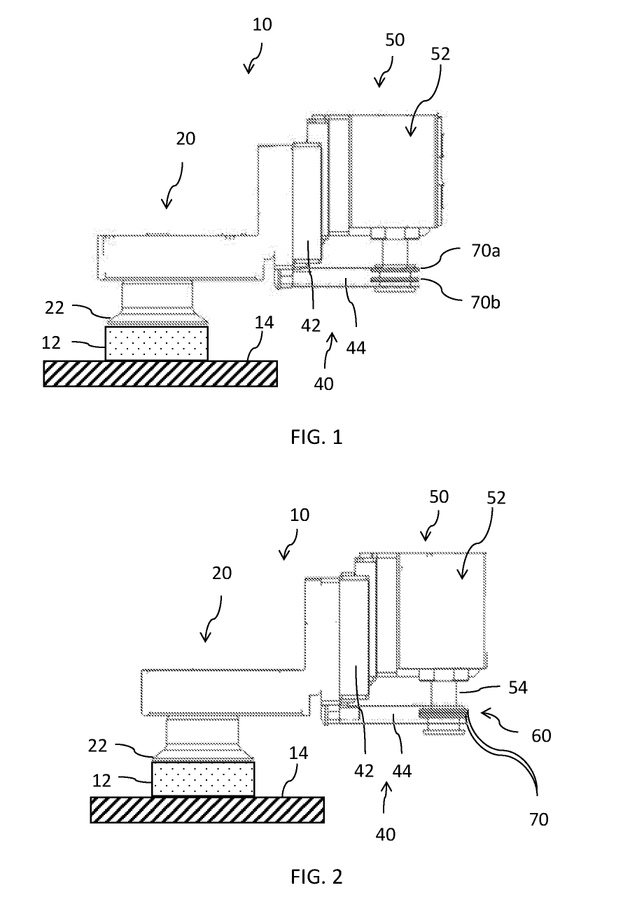

For purposes of brevity and clarity, descriptions of embodiments of the present disclosure are directed to an automated picking apparatus and a method for picking an object or a set of objects disposed on a surface, in accordance with the drawings in FIG. 1 to FIG. 5. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail as not to unnecessarily obscure aspects of the embodiments of the present disclosure.

In a representative or exemplary embodiment of the present disclosure, an automated picking apparatus 10 for picking an object/component/work pieces 12 or a set of objects 12 disposed on a surface 14, as well as a method for picking the object 12, is described hereinafter.

The automated picking apparatus 10 comprises a set of picking devices 20 that is displaceable toward the surface 14 for picking the set of objects 12. In the representative embodiment as shown in FIG. 1, the set of picking devices 20 comprises a single picking device 20 for picking one or more objects 12 successively. Alternatively, the set of picking devices 20 may comprise a plurality of picking devices 20 operable for picking the object 12 or the set of objects 12 successively or simultaneously.

The picking device 20 is for picking up a work piece/component/object 12 from the surface 14 on which the object is disposed or residing. In the representative embodiment as shown in FIG. 1, the picking device 20 comprises an end effector 22 which is attached to the end of the picking device 20 for contacting and picking the object 12. To pick up the object 12, the picking device 20 is displaced and extended until the end effector 22 comes into contact with the object 12. Upon contact with the object 12 and when the end effector 22 is pressed against the object 12, the end effector 22 applies suction or picking forces to pick or lift up the object 12. For example, the end effector 22 may comprise a vacuum suction device, enabling the air between the vacuum suction device and the object to be squeezed out and the object is attached to the vacuum suction device due to the suction effect. When the picking device 20 is retracted, the vacuum suction device together with the attached object 12 are consequently retracted and lifted away from the surface 14. Alternatively, the end effector 22 may comprise other mechanisms for attaching the object 12 to the picking device 20 in place of the vacuum suction device, such as a magnetic device for ferrite-based objects 12, as readily understood by the skilled person.

The automated picking apparatus 10 further comprises a set of compensator devices 60 coupled to the set of picking devices 20. In the representative embodiment, with further reference to FIG. 1 and FIG. 2, the picking device 20 is co-operably connected to a compensator device 60. The picking device 20 is connected or coupled to the corresponding or associated compensator device 60 via a linkage structure 40. The linkage structure 40 enables the picking device 20 and the compensator device 60 to cooperate with each other. The linkage structure 40 comprises a linear guide 42 for guiding the displacement of the picking device 20 toward the surface 14, and a linkage bar 44 for structurally connecting or coupling the picking device 20 and the compensator device 60.

The linear guide 42 guides the movement of the picking device 20 in a linear direction, i.e. toward the surface 14 for picking the object 12. The linear movement of the picking device 20 may be guided by the interlocking grooves or sliding mechanisms, as readily understood by the skilled person, between the linear guide 42 and the picking device 20 to which the linear guide 42 is attached.

The automated picking apparatus 10 further comprises an actuating mechanism 50 operable for displacing the picking device 20 toward the surface 14 for picking the object 12. In some alternative embodiments, the automated picking apparatus 10 comprises a set of actuating mechanisms 50, each operable for displacing one from the set of picking devices 20. The set of actuating mechanisms 50 may be operable simultaneously so as to pick up the object or the set of objects 12 at the same time. Yet alternatively, the set of actuating mechanisms 50 may be operable successively so as to pick up the object or the set of objects 12 one at a time.

As shown in FIG. 1 and FIG. 2, each compensator device 60 is co-operably connected to the picking device 20, such that operation of the actuating mechanism 50 operates the compensator device 60 and displaces the picking device 20 co-operably connected thereto. The operation of the compensator device 60 and displacement of the picking device 20 may occur simultaneously upon operation or activation of the actuating mechanism 50. The linkage bar 44 couples the actuating mechanism 50 and the compensator device 60 to the picking device 20 such that the picking device 20 is extended or retracted in tandem with the actuation of the actuating mechanism 50, and that the compensator device 60 is operated in association with the actuation of the actuating mechanism 50.

The actuating mechanism 50 may be of a pneumatic type comprising a pneumatic system 52 and a shaft 54. Alternatively, the actuating mechanism 50 may be of a hydraulic or electro-mechanical type. In the pneumatic actuating mechanism 50, pressurized air is used by the pneumatic system 52 to extend and retract the shaft 54. As the actuating mechanism 50 extends or retracts the shaft 54, the movement/displacement is transferred to the picking device 20 through the linkage bar 44. As a result, the picking device 20 and the end effector 22 also extend or retract correspondingly. The movement/displacement of the picking device 20 is guided by the linear guide 42, such that the picking device 20 can only move in the direction as configured by the linear guide 42, i.e. toward the surface 14.

The shaft 54 of the actuating mechanism 50 and the linkage bar 44 of the linkage structure 40 are co-operably connected to the compensator device 60, enabling the compensator device 60 to operate in association with the actuation of the actuating mechanism 50 and to cooperate with the picking device 20.

The compensator device 60 comprises a plurality of magnetic elements 70. The magnetic elements 70 may be permanent magnets, electro-magnets, magnetic devices, and/or magnetized devices, as readily known to the skilled person. The plurality of magnetic elements 70 includes at least a first magnetic element 70a and a second magnetic element 70b separated by a distance and arranged to repel away from each other. The first magnetic element 70a and second magnetic element 70b are arranged with same poles facing each other so as to effect a repulsion force repelling them away from each other. The first magnetic element 70a and second magnetic element 70b are oriented such that the repulsion force acts along the same linear direction as the displacement of the picking device 20 toward the surface 14.

As the first magnetic element 70a and second magnetic element 70b are spaced apart by the distance (as shown in FIG. 1), operation of the actuating mechanism 50 operates the compensator device 60, which in turn reduces the distance. The compensator device 60 may displace the first magnetic element 70a toward the second magnetic element 70b, the second magnetic element 70b toward the first magnetic element 70a, or both magnetic elements 70a, 70b toward each other for reducing the distance therebetween. In some alternative embodiments, the compensator device 60 may comprise three or more magnetic elements 70 in a similar repulsion arrangement. Operation of the compensator device 60 would reduce the distances between any pair of the magnetic elements 70.

The compensator device 60 cooperates with the picking device 20 such that when the actuating mechanism 50 is in operation, the picking device 20 is displaced toward the surface 14 and the distance between the first magnetic element 70a and second magnetic element 70b is reduced. When the picking device 20 approaches the surface 14 until the end effector 22 of the picking device 20 contacts the object 12, continued operation of the actuating mechanism 50 subsequent to the contact between the picking device 20 and the object 12 further reduces the distance.

The presence of the distance enables the actuating mechanism 50 to continue operating and pushing the first and second magnetic elements 70a, 70b toward each other, without exerting excessive force or pressure on the object 12 by the end effector 22. This allows for compensation of height differences due to non-planarity of the surface 14 or unevenness of the surface of the object 12, wherein the compensation is determined by or associated with the distance. For example, multiple objects 12 may be disposed on the surface 14 which may be slightly non-planar. One or more of the objects 12 may be at a slightly different height from the other objects 12. When the picking devices 20 approach the objects 12, some of the end effectors 22 may contact some objects 12 first, while other end effectors 22 are still a slight distance away from the other objects 12. The actuating mechanism 50 needs to continue operation in order for to move the other end effectors 22 so that all of them are in contact with all objects 12. For the end effectors 22 which are already in contact with the objects 12, continued operation of the actuating mechanism 50 would further reduce the distance of the compensator devices 60 co-operably connected to the picking devices 20 (comprising said end effectors 22). Alternatively, multiple picking devices 20 may be picking one large object 12, the surface of which is uneven, such that some end effectors 22 contact certain areas of the object 12 first before other end effectors 22. The actuating mechanism 50 continues to extend all the end effectors 22 until all make contact with the large object 12, reducing the distance between the first magnetic element 70a and second magnetic element 70b of the compensator devices 60 of the picking devices 20 which have made earlier contact with the object 12. FIG. 2 shows the magnetic elements 70a, 70b in the fully compressed state, i.e. the distance is reduced to zero or substantially zero. The allowance of the distance reduces or attenuates the forces of said end effectors 22 on the objects 12. The reduction of the distance in each compensator device 60 may begin simultaneously with the displacement of the picking device 20, or may occur successively one after the other.

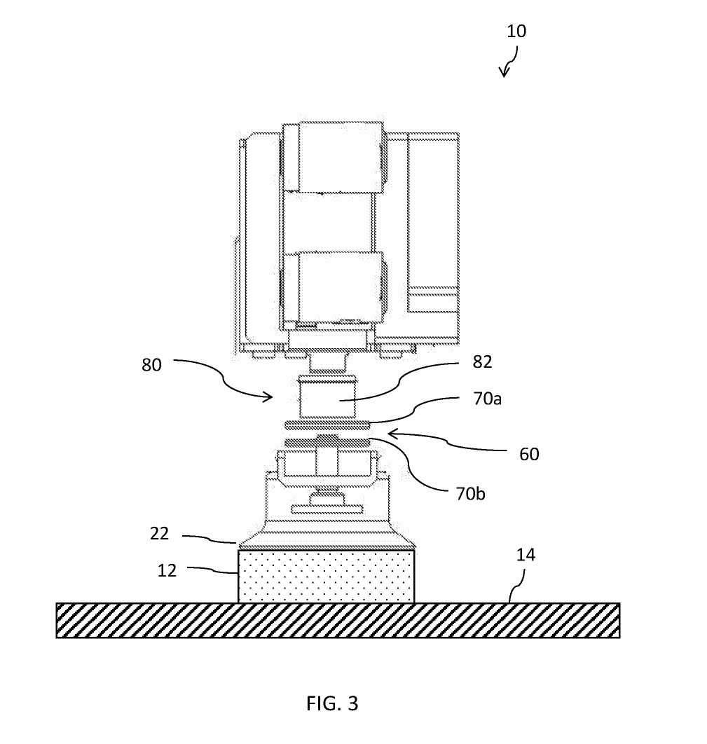

The compensator device comprises a magnetic element carrier 80 for assisting and guiding the movement of the first magnetic element 70a and second magnetic element 70b relative to each other, As the direction of movement of first magnetic element 70a and second magnetic element 70b relative to each other can be unpredictable. With reference to FIG. 3, the magnetic element carrier 80 comprises a round tube or trunk 82 while the first magnetic element 70a and the second magnetic element 70b are made into rings or annular structures which can fit around the trunk 82. The inner diameter of the ring of first magnetic element 70a and the second magnetic element 70b is big enough to allow free movement of the first magnet 70a and the second magnetic element 70b along the trunk 82 but small enough to keep the first magnetic element 70a and the second magnetic element 70b concentric and aligned to each other. Alternative design and shape of the magnetic element carrier 80 and magnetic elements 70 are possible, such as a square trunk with magnetic elements of a square hollow centre. The material used in making the magnetic element carrier 80 is preferably non-magnetic, such as plastic, so that the magnetic elements 70 can move freely along the trunk 82 and not be attracted to the trunk 82 as would be the case if the trunk 82 is made of a magnetic material.

The magnetic element carrier 80 is fitted to the shaft 54 of the actuating mechanism 50. Operation of the actuating mechanism 50 would cause the shaft 54 to actuate and in turn displace the first magnetic element 70a toward the second magnetic element 70b, thereby reducing the distance therebetween.

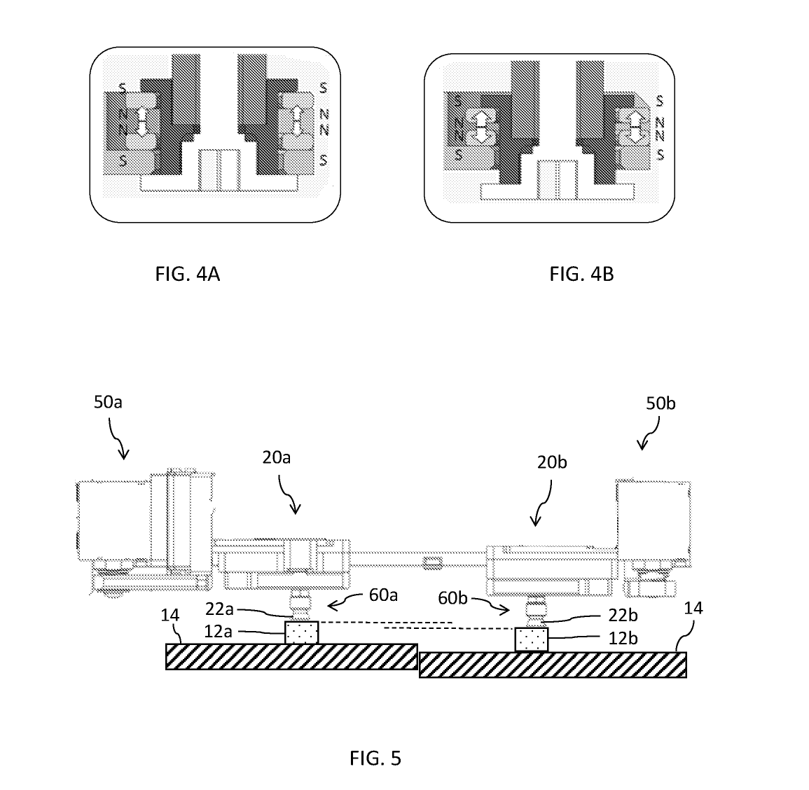

FIG. 4A and FIG. 4B illustrate the compensator device 60 having the first magnetic element 70a and the second magnetic element 70b in an annular or ring-like form, In FIG. 4A, the picking device 20 is approaching the surface 14, without contact, and the first and second magnetic elements 70a, 70b are separated by the distance. As the picking device 20 moves toward the surface 14 due to operation of the actuating mechanism 50, the distance begins to reduce. FIG. 4B shows the picking device 20 contacting the surface 14 and the distance is reduced as compared to the initial distance as shown in FIG. 4A. Continued operation of the actuating mechanism 50 would cause the distance to reduce even further, but the picking device 20 will remain at the same position on the surface 14.

The automated picking apparatus 10 is used for picking an object or a set of objects 12 disposed on a surface 14. In the representative embodiment, there is a single object 12 disposed on the surface 14. To pick the object 12, an end effector 22 of a picking device 20 is firstly positioned at a distance away from the object 12, along the path where the end effector 22 can move towards the object 12 as guided by the linear guide 42. In this state where the end effector 22 is not in contact with the object 12, the repulsion force between the first magnetic element 70a and second magnetic element 70b causes them to move away from each other along the magnetic element carrier 80. The initial distance between the first magnetic element 70a and the second magnetic element 70b is predetermined such that the initial repulsion force between the first magnetic element 70a and second magnetic element 70b is correspondingly predetermined. The distance can be decreased for stronger repulsion force between the first magnetic element 70a and second magnetic element 70b. The repulsion force may also be adjusted by using magnetic elements 70 of different magnetic strengths.

The actuating mechanism 50 is then activated and the pressurized air in the pneumatic system 52 extends or actuates the shaft 54. The extension/actuation of shaft 54 carries with it the magnetic element carrier 80 fitted thereto, causing the first magnetic element 70a to push the second magnetic element 70b using the repulsion force between them. The force on the second magnetic element 70b causes the linkage bar 44 to move correspondingly. The movement of the linkage bar 44 causes the picking device 20 to move in tandem because the linkage bar 44 and the picking device 20 are coupled together. As a result, the end effector 22 is extended or displaced towards the surface 14 for picking the object 12 disposed thereon.

The repulsion force between first magnetic element 70a and second magnetic element 70b should be sufficient to minimize the lag between the extension of the shaft 54 and the picking device 20. Ideally, both the shaft 54 and the picking device 20 should extend in tandem. However, insufficient repulsive force between first magnetic element 70a and second magnetic element 70b may result in the shaft 54 and first magnetic element 70a moving for a short period of time, reducing the distance between first magnetic element 70a and second magnetic element 70b, before there is sufficient repulsion force between first magnetic element 70a and second magnetic element 70b to move the second magnetic element 70b and the linkage bar 44 connected thereto to extend the picking device 20. Thus, the extension of picking device 20 will lag behind the extension of the shaft 54 by a short period of time. The initial repulsion force due to the initial distance between the first magnetic element 70a and second magnetic element 70b should be sufficiently strong so that the lag is significantly minimized

The extension of end effector 22 will continue until the end effector 22 makes contact with the object 12 to be picked up. When the movement of the end effector 22 is stopped by the object 12, the linkage bar 44 and the second magnetic element 70b will also stop moving.

Any further extension of the shaft 54 will only move the first magnetic element 70a towards the second magnetic element 70b. As a result, the distance or space between first magnetic element 70a and second magnetic element 70b is further decreased. When first magnetic element 70a advances until it makes contact with second magnetic element 70b, the shaft 54 cannot be extended further.

After the end effector 22 is pressed against the object 12 which is now attached to the end effector 22, e.g. by a suction force, the object 12 is ready to be lifted away or picked from the surface 14. To lift the object 12, the pneumatic system 52 is activated to retract the shaft 54. Retraction of the shaft 54 will move the linkage bar 44 which is coupled to the picking device 20. As a result, the picking device 20 and the end effector 22 are also retracted along the path as configured by the linear guide 42. The object 12 can then be moved or transferred to its next position or destination.

While the above description is in relation to a representative embodiment wherein there is a single object 12 on the surface 14 to be picked up by a picking device 20, the automated picking apparatus 10 may also be used in other embodiments, particularly wherein there are multiple objects 12 disposed on the surface 14. In these other embodiments, the multiple objects 12 are to be picked up by an equivalent number of picking devices 20 at the same time. In another embodiment, multiple picking devices 20 are used to pick up a large object 12, the surface of which is uneven, such that some end effectors 22 make contact with the object 12 before other end effectors 22.

With reference to FIG. 5, there are two objects 12a and 12b to be simultaneously picked up by two picking devices 20a and 20b with corresponding end effectors 22a, 22b, respectively. The objects 12a, 12b are both disposed on a horizontal surface 14. However, due to non-planarity or defects of the surface 14, the object 12a is slightly higher than the other object 12b, relative to the true horizontal. This means that object 12a is nearer to the end effector 22a than is the object 12b to the end effector 22b. When both end effectors 22a, 22b are lowered to pick up the objects 12a, 12b, the end effector 22a makes contact with the object 12a before the end effector 22b comes into contact with the object 12b. The picking devices 20a, 20b may be displaced or lowered by separate actuating mechanisms 50a, 50b, respectively, that are connected to a common pneumatic system. The common pneumatic system allows the actuating mechanisms 50a, 50b to operate simultaneously, such that the end effectors 22a, 22b are lowered simultaneously. Alternatively, there may be a common actuating mechanism for simultaneous operation and displacement of the picking devices 20a, 20b.

The picking devices 20a, 20b are displaced to a point when only the end effector 22a is in contact with the object 12a, while the end effector 22b is still separated from the object 12b, due to the non-planarity of the surface 14. The object 12b cannot be picked up by the end effector 22b at this moment and further extension of end effector 22b is necessary. Therefore, both picking devices 20a, 20b will be lowered toward the surface 14. This further extension of the picking devices 20a, 20b, as well as the corresponding end effectors 22a, 22b, will extend the end effector 22b until it contacts the object 12b for picking thereof. However, as the end effector 22a was already in contact with the object 12a prior to this further extension, the further extension will further reduce the distance between first and second magnetic elements of the compensator device 60a co-operably connected to the picking device 20a until the end effector 22b makes contact with the object 12b. The distance between first and second magnetic elements in the compensator device 60a provides the necessary compensation for the height difference between the objects 12a, 12b, allowing the end effector 22b to come into contact with object 12b, while at the same time preventing the end effector 22a from damaging the object 12a, as the distance between the first and second magnetic elements in the compensator device 60a helps to attenuate the forces exerted on the object 12a.

When both the end effectors 22a, 22b are in contact with the corresponding objects 12a, 12b, the objects 12a, 12b can be picked up simultaneously and transferred to the desired destination. While two magnetic elements are used in describing the embodiment with reference to FIG. 5, greater height compensation, that is ability to compensate for greater differences in distance or height between two or more objects 12, can be achieved by using more than two magnetic elements 70 arranged with same pole of neighbouring magnetic elements facing each other. It would be readily understood by the skilled person to modify the embodiments described in the present disclosure for implementation or use with multiple objects 12, multiple picking devices 20, and/or multiple compensator devices 60 with multiple magnetic elements 70.

The compensator device 60 or set of compensator devices 60 thus allows for compensation of height differences of the objects 12 placed on a non-planar or defective surface 14. The use of magnetic elements 70 for the compensation devices 60 is advantageous because there will be minimal physical contact (the repulsion force is applied across an empty space) with other components, thereby minimizing damage. Due to less moving components, the risk of jamming or failures is significantly mitigated, thereby improving the reliability of the compensation devices 60 and consequently of the automated picking apparatus 10.

The automated picking apparatus 10 may be connected to a computer system for automating the process of picking the multiple objects 12 disposed on the surface 14, simultaneously or successively. The improved reliability of the compensation devices 60 enables quicker operation of the automated picking apparatus 10 due to the lower risk of failures, thereby allowing objects 12 to be more quickly picked and then transferred to the desired destination.

In the foregoing detailed description, embodiments of the present disclosure in relation to an automated picking apparatus and a method for picking an object or a set of objects disposed on a surface are described with reference to the provided figures. The description of the various embodiments herein is not intended to call out or be limited only to specific or particular representations of the present disclosure, but merely to illustrate non-limiting examples of the present disclosure. For example, the aforementioned embodiments are directed toward picking of objects disposed on a horizontal surface. It would be readily understood by the skilled person that the same apparatus can be implemented or used for picking objects disposed on a non-horizontal surface, e.g. vertical wall.

The present disclosure serves to address at least some of the mentioned problems and issues associated with the prior art. Although only some embodiments of the present disclosure are disclosed herein, it will be apparent to a person having ordinary skill in the art in view of the present disclosure that a variety of changes and/or modifications can be made to the disclosed embodiments without departing from the scope of the present disclosure. The scope of the present disclosure as well as the scope of the following claims is not limited to embodiments described herein.

1. An automated picking apparatus comprising:
a picking device for picking an object; and
a compensator device operable in cooperation with the picking device, the compensator device comprising a first magnetic element and a second magnetic element separated by a distance and arranged to repel away from each other;
wherein the distance between the first and second magnetic elements of the compensator device is adjustable with displacement of the picking device relative to the object; and
wherein displacement of the picking device subsequent to contact between the picking device and the object reduces the distance between the first and second magnetic elements of the compensator device.

2. The automated picking apparatus of claim 1,
wherein the picking device is part of a plurality of picking devices including a first picking device and a second picking device and the compensator device is part of a plurality of compensator devices including a first compensator device and a second compensator device; and
wherein displacing the plurality of picking devices, subsequent to contact between the first picking device and the object, reduces the distance between the first and second magnetic elements of the first compensator device.

3. The automated picking apparatus of claim 1, wherein the compensator device comprises a carrier for carrying the first and second magnetic elements.

4. The automated picking apparatus of claim 1, wherein the distance separating the first and second magnetic elements provides an initial repulsion force therebetween.

5. The automated picking apparatus of claim 1, wherein the picking device comprises a vacuum suction device.

6. The automated picking apparatus of claim 1, wherein the automated picking apparatus is connected to a computing system for automating operation thereof.

7. The automated picking apparatus of claim 1, further comprising a linkage structure wherein the linkage structure comprises:
a linear guide for guiding displacement of the picking device toward the object; and
a linkage bar for coupling the picking device to the compensator device.

8. The automated picking apparatus of claim 1, further comprises an actuating mechanism operable for displacing the picking device toward the object.

9. The automated picking apparatus of claim 8 wherein the actuating mechanism is activated by a pneumatic system.

10. The automated picking apparatus of claim 1, wherein the displacement of the picking device occurs simultaneously with the adjustment of the distance between the first and second magnetic elements.

11. The automated picking apparatus of claim 1, wherein the first magnetic element is displaceable toward the second magnetic element for reducing the distance therebetween.

12. The automated picking apparatus of claim 11, wherein displacement of the first magnetic element toward the second magnetic element is in a same direction as displacement of the picking device toward the object.

13. An automated picking apparatus for picking a set of objects, the set of objects including a first object and a second object, the automated picking apparatus comprising:
a set of picking devices including a first picking device and a second picking device for picking the first and second objects, respectively; and
a set of compensator devices operable in cooperation with the set of picking devices, the set of compensator devices including a first compensator device and a second compensator device, each of the first and second compensator devices comprising a first magnetic element and a second magnetic element separated by a distance and arranged to repel away from each other,
wherein the distances between the first and second magnetic elements of the first and second compensator devices are adjustable with displacement of the first and second picking devices relative to the first and second object, respectively;
wherein the first picking device contacts the first object before the second picking device contacts the second object; and
wherein subsequent to contact between the first picking device and the first object, displacement of the second picking device toward the second object reduces the distance between the first and second magnetic elements of the first compensator device.

14. The automated picking apparatus of claim 13 further comprising a set of linkage structures including a first linkage structure and a second linkage structure, each of the first and second linkage structures comprises:
a linear guide; and
a linkage bar;
wherein the linear guide of the first and second linkage structures is for guiding the displacement of the first and second picking devices toward the first and second object respectively; and
the linkage bar of the first and second linkage structures is for coupling the first and second picking devices to the first and second compensator devices, respectively.

15. The automated picking apparatus of claim 13 further comprising a set of actuating mechanisms operable for displacing the set of picking devices for picking the set of objects.

16. The automated picking apparatus of claim 15 wherein the set of actuating mechanisms is activated by a pneumatic system.

17. The automated picking apparatus of claim 13, wherein the first magnetic element of the first and second compensator devices is displaceable toward the second magnetic element of the first and second compensator devices respectively for reducing the distance therebetween.

18. The automated picking apparatus of claim 13, wherein the automated picking apparatus is connected to a computing system for automating operation thereof.

19. A method for picking an object, the method comprising:
displacing a picking device toward the object;
activating a compensator device, wherein the compensator device is operable in cooperation with the picking device, the compensator device comprising a first magnetic element and a second magnetic element separated by a distance and arranged to repel away from each other; and
reducing the distance between the first and second magnetic elements of the compensator device in response to activation of the compensator device and while the picking device is being displaced toward the object,
wherein subsequent to contact between the picking device and the object, continued activation of the compensator device further reduces the distance between the first and second magnetic elements of the compensator device.

20. The method of claim 19 further comprises the steps of:
positioning the picking device within displaceable distance of the picking device from the object;
aligning the picking device to the object; and
activating a pneumatic system.

21. The method of claim 19 further comprises the steps of:
retracting the picking device;
lifting the object; and
moving the picking device to a new position.

22. A method for picking a set of objects, the set of objects including a first object and a second object, the method comprising:
displacing a set of picking devices including a first picking device and a second picking device, for picking the first and second objects, respectively;
activating a set of compensator devices, the set of compensator devices coupled to the set of picking devices and including a first compensator device and a second compensator device, wherein each of the first and second compensator devices comprises a first magnet and a second magnet separated by a distance and arranged to repel away from each other, and wherein the first and second compensator devices are operable in cooperation with the first and second picking devices, respectively;
reducing the distances between the first and second magnet of the first and second compensator devices in response to activation thereof and while the first and second picking devices are being displaced toward the first and second object, displacing the first picking device until the first picking device contacts the first object before the second picking device contacts the second object;
displacing the second picking device toward the second object subsequent to contact between the first picking device and the first object; and
further reducing the distance between the first and second magnets of the first compensator device,
wherein the distance between the first and second magnets of the first compensator device is reduced until the second picking device contacts the second object.

23. A method for picking an object, the method comprising:
displacing a set of picking devices, the set of picking devices including a first picking device and a second picking device, toward the object;
activating a set of compensator devices, the set of compensator devices coupled to the set of picking devices and including a first compensator device and a second compensator device, wherein each of the first and second compensator devices comprises a first magnet and a second magnet separated by a distance and arranged to repel away from each other, and wherein the first and second compensator devices are operable in cooperation with the first and second picking devices, respectively;
reducing the distances between the first and second magnets of the first and second compensator devices in response to activation thereof and while the first and second picking devices are being displaced toward the object,
displacing the first picking device until the first picking device contacts the object before the second picking device contacts the object;
displacing the second picking device toward the object subsequent to contact between the first picking device and the object; and
further reducing the distance between the first and second magnets of the first compensator device,
wherein the distance between the first and second magnets of the first compensator device is reduced until the second picking device contacts the object.
